(19) United States
(12) Patent Application Publication
(10) Pub. No.: US 2004/0032539 A1
(43) Pub. Date: Feb. 19, 2004

(54) Rear-projection television set

(76) Inventor: Sz-Lung You, Kaohsiung City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/222,849

(22) Filed: Aug. 19, 2002

(51) Int. Cl. H04N 5/64; H04N 9/31

(52) U.S. Cl. 348/744; 348/781

(57) ABSTRACT

A rear-projection television set includes a television screen, an image projector, first and second imaging lens units, and first and second reflecting mirror sets. The television screen has an optical axis and first and second image rendering portions disposed on opposite sides of the optical axis. The image projector is disposed rearwardly of the television screen and is aligned with the optical axis. The first and second imaging lens units cooperate to separate the image output of the image projector into first and second image portions. Each of the first and second reflecting mirror sets receives a respective one of the first and second image portions from the first and second imaging lens units, and projects the respective one of the first and second image portions to a respective one of the first and second image rendering portions of the television screen.

### BACKGROUND OF THE INVENTION

1. Field of the Invention

The invention relates to a television set, more particularly to a rear-projection television set that is relatively small in size.

2. Description of the Related Art

Referring to FIG. 1, a conventional rear-projection television set is shown to comprise a television screen (S2), a once-reflection mirror unit (R7), a twice-reflection mirror unit (R8), and a single-light-beam image projector (PJ). The image projector (PJ) generally includes a light source, a condenser lens set, a video display device and an imaging lens unit. In use, the once-reflection mirror unit (R7) receives an image output from the image projector (PJ) and reflects the same to the twice-reflection mirror unit (R8). The twice-reflection mirror unit (R8) then projects the image output to the television screen (S2) for image display.

FIG. 2 is a schematic view illustrating two image reflecting routes of the conventional rear-projection television set, wherein reference numeral 31 denotes incident light, reference numeral 32 denotes once-reflected light, and reference numeral 33 denotes twice-reflected light. Since each reflection reverses the phase of the resulting image in relation to the source image, the phase of the once-reflected light 32 is opposite to that of the incident light 31, whereas the phase of the twice-reflected light 33 is opposite to that of the once-reflected light 32 and is thus identical to that of the incident light 31.

Due to the once-reflection and twice-reflection mirror units (R7, R8), the depth of the conventional rear-projection television set can be reduced to about one-half of that required when the once-reflection and twice-reflection mirror units (R7, R8) are not installed. FIG. 3 illustrates how the depth of the conventional rear-projection television set is reduced with the use of the once-reflection and twice-reflection mirror units (R7, R8). In FIG. 3, reference numeral (E) denotes a virtual point source for projecting an image output onto the television screen (S2) in a condition where the once-reflection and twice-reflection mirror units (R7, R8) are not installed, whereas reference numeral (B) denotes an idealized point source for projecting the image output onto the television screen (S2) in a condition where the once-reflection and twice-reflection mirror units (R7, R8) are installed. The television screen (S2) is located at line AB. In the conventional rear-projection television set, the idealized point source (B) and the once-reflection mirror unit (R7) can be deemed to be the same projecting source. A reflecting plane functionally equivalent to the twice-reflection mirror unit (R8) is located at line AC.

In theory, for optimum image projection, the triangle formed by points (A, B, E) should be an equilateral triangle. If angle ∠AEB is greater than 60 degrees, portions of the image output will fall out of the area of the television screen (S2). In practice, the angle ∠AEB is chosen to be slightly smaller than 60 degrees. However, if the angle ∠AEB is much less than 60 degrees, the area of the television screen (S2) will be under-utilized. As shown in FIG. 3, the distance between point (C) and line AB is D1, whereas the distance between point (E) and line AB is D2. When line AC divides the triangle ABE into two equal parts, the ratio of the distance (D1) to the height of the television screen (S2) is as follows:

Since angle ∠BAC is equal to 30 degrees,

cos ∠BAC=cos 30=AC/AB=√3/2.

Moreover, since D2=AC and D1=½D2, D1/AB=½AC/AB=½·√3/2≈0.43.

In other words, the depth (D2) of the conventional rear-projection television set should be no smaller than 0.43 times the height of the television screen (S2) for optimum image projection.

Referring once again to FIG. 1, in principle, the design of the television screen (S2) should take into account a variety of factors, such as refined resolution, homogeneous distribution of light intensity, wide viewing angle, and high gain. FIG. 4A is a cross-sectional view of the conventional television screen (S2). In FIG. 4A, reference numeral 61 denotes a virtual point source at a focal point of the television screen (S2). The television screen (S2) is a planar-type Fresnel lens, which refracts light beams 62 that radiate from the virtual point source 61 into parallel light beams 63 in a manner similar to that which can be achieved with the use of a planoconvex lens S20 (see FIG. 4B) The television screen (S2) is made of transparent acrylic material, and has a surface formed with concentric light guiding projections (S25), each of which has a generally serrated cross-section with an inclined surface and a transverse surface disposed closer to an optical axis of the television screen (S2) in relation to the inclined surface. The inclined surfaces of adjacent ones of the light guiding projections (S25) have varying slopes, and the slopes of the inclined surfaces of the light guiding projections (S25) increase in a radial outward direction relative to the optical axis. The aforesaid television screen (S2) can have a gain of as high as 5.5 times, and can eliminate hot spots that result from uneven distribution of light intensity.

As evident from FIG. 1, although the structure of the conventional rear-projection television set is relatively simple, the arrangement of the once-reflection and twice-reflection mirror units (R7, R8) mandates the location of the image projector (PJ) at a level lower than a bottom edge of the television screen (S2), which results in a corresponding increase in the entire height of the television set. It is noted that the additional space requirement below the television screen (S2) is not related to the size of the image projector (PJ) or the accompanying electronic components, and is attributed primarily to the use of two image reflecting routes for image projection. Therefore, in the conventional rear-projection television set, all electronic and optical components are generally located below the television screen (S2).

Space utilization is a very important consideration nowadays. Thus, there is always a need for a rear-projection television set that is much smaller in size as compared to the prior art.

### SUMMARY OF THE INVENTION

Therefore, the main object of the present invention is to provide a relatively small rear-projection television set.

Accordingly, a rear-projection television of this invention comprises a television screen, an image projector, first and second imaging lens units, and first and second reflecting mirror sets.

The television screen has an optical axis, and first and second image rendering portions disposed on opposite sides of the optical axis.

The image projector is disposed rearwardly of the television screen, is aligned with the optical axis, and generates an image output.

The first and second imaging lens units are disposed between the image projector and the television screen on the opposite sides of the optical axis, and cooperate to separate the image output of the image projector into first and second image portions.

The first and second reflecting mirror sets are disposed rearwardly of the television screen on the opposite sides of the optical axis. Each of the first and second reflecting mirror sets receives a respective one of the first and second image portions from the first and second imaging lens units, and projects the respective one of the first and second image portions to a respective one of the first and second image rendering portions of the television screen.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating a conventional rear-projection television set;

FIG. 2 is a schematic diagram illustrating two image reflecting routes of the conventional rear-projection television set of FIG. 1;

FIG. 3 illustrates the conventional rear-projection television set of FIG. 1 under ideal minimum depth conditions;

FIG. 4A is a cross-sectional view of a television screen of the conventional rear-projection television set of FIG. 1;

FIG. 4B is a cross-sectional view of a planoconvex lens functionally equivalent to the conventional television screen of FIG. 4A;

FIG. 5 is a schematic diagram illustrating a preferred embodiment of a rear-projection television set according to the present invention;

FIG. 6 is a fragmentary assembled perspective view of the preferred embodiment;

FIG. 7 is a schematic diagram illustrating the image reflecting routes of the rear-projection television set of the preferred embodiment;

FIG. 8 illustrates the rear-projection television set of the preferred embodiment under ideal minimum depth conditions;

FIG. 9 is a schematic diagram illustrating the effect of a diaphragm in the preferred embodiment of the present invention;

FIG. 10 is a schematic diagram illustrating how images are projected in the preferred embodiment of the present invention;

FIGS. 11A and 11B respectively show contrast distribution of a single image portion and a combined image output in the preferred embodiment of the present invention;

FIG. 12A is a vertical cross-sectional view of a television screen of the preferred embodiment;

FIG. 12B is a vertical cross-sectional view of a lens functionally equivalent to the television screen of FIG. 12A;

FIG. 13A is a horizontal cross-sectional view of the television screen of the preferred embodiment;

FIG. 13B is a horizontal cross-sectional view of the lens functionally equivalent to the television screen of FIG. 13A;

FIG. 14 is a partly cutaway perspective view of the television screen of the preferred embodiment; and

FIG. 15 is a schematic diagram illustrating modified once-reflection mirror units employed in an alternative embodiment of the present invention.

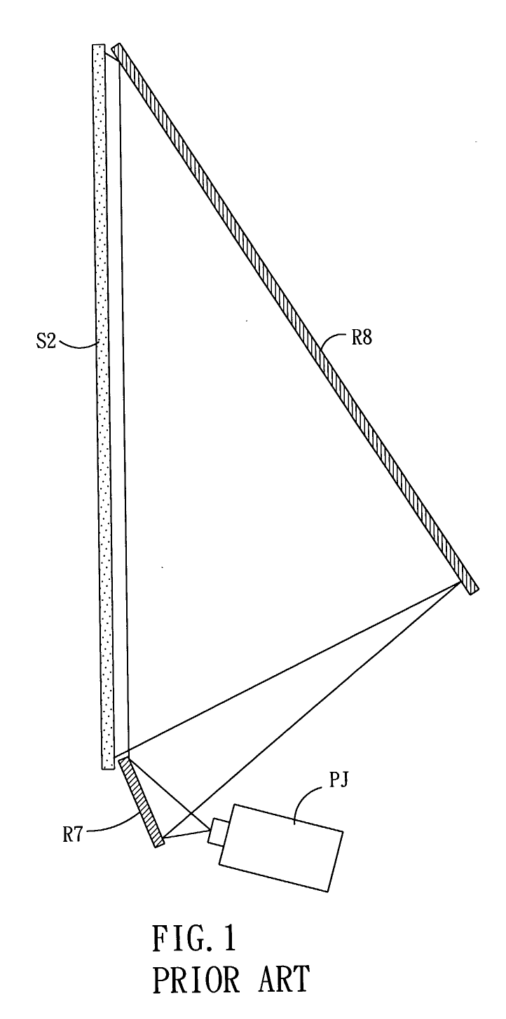

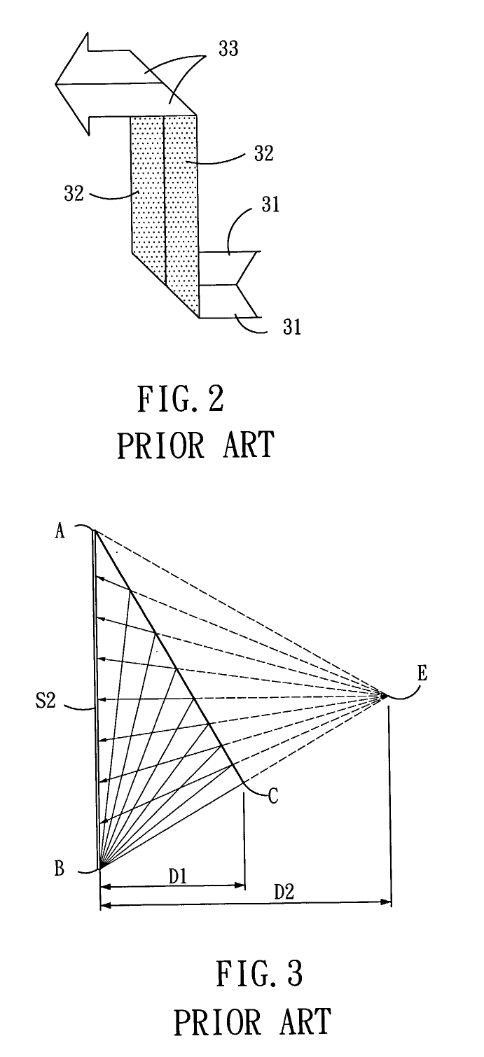

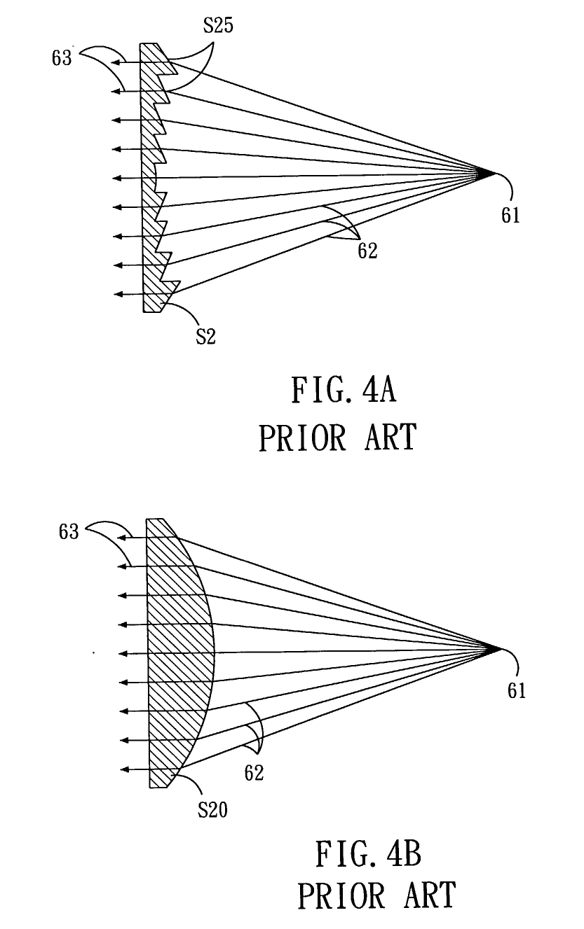

### DETAILED DESCRIPTION OF THE PREFERRED EMBODIMENTS

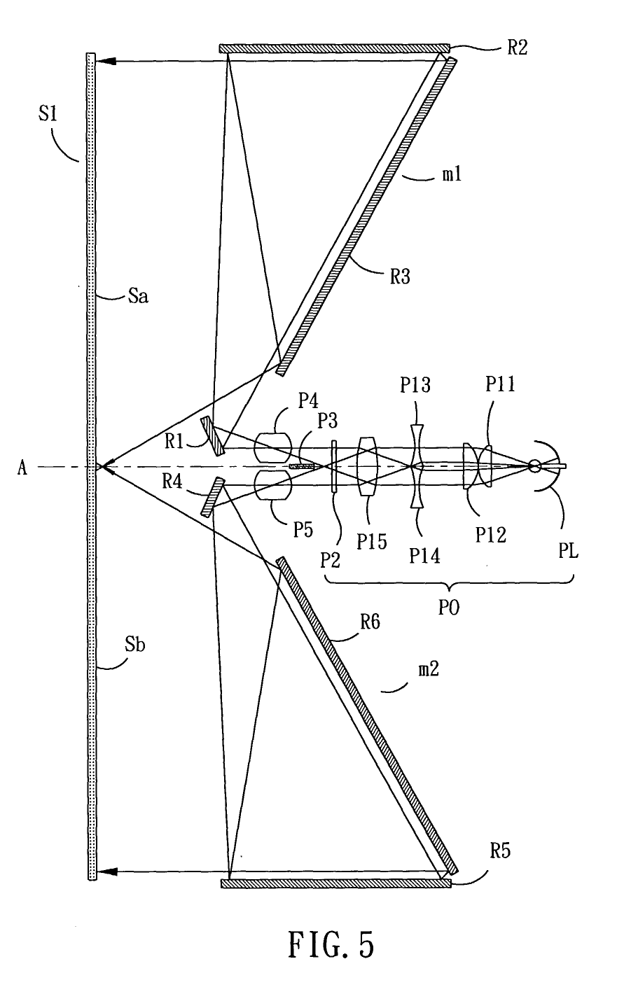

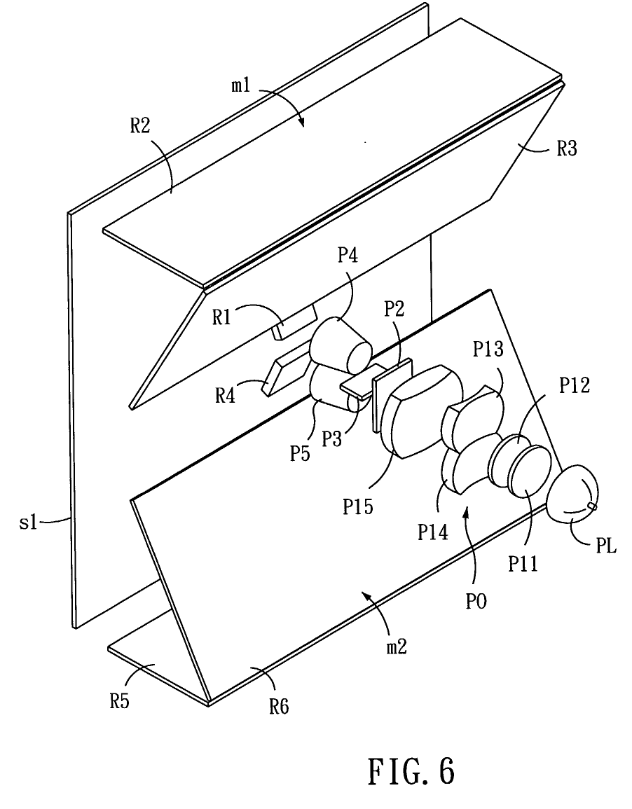

Referring to FIGS. 5 and 6, the preferred embodiment of a rear-projection television set according to the present invention is shown to include a television screen (S1), an image projector (P0), first and second imaging lens units (P4, P5), a diaphragm (P3), and first and second reflecting mirror sets (m1, m2).

The television screen (S1) has an optical axis (A) and first and second image rendering portions (Sa, Sb) disposed on opposite upper and lower sides of the optical axis (A). The television screen (S1) provides the functions of image display, gain, and visual angle widening.

The image projector (P0) is disposed rearwardly of the television screen (S1), is aligned with the optical axis (A), and generates an image output. The image projector (P0) includes a light source module and a video display device (P2) disposed at an output side of the light source module. The light source module includes a light source (PL) and a condenser lens set disposed between the light source (PL) and the video display device (P2). The condenser lens set includes lenses (P11, P12, P13, P14, P15). The video display device (P2) is a known transparent liquid crystal display (LCD) device capable of compound imaging of three primary colors in this embodiment. Alternatively, the video display device (P2) maybe implemented using three liquid crystal display (LCD) devices for generating images in the three primary colors that are subsequently compounded via an X-Cube, or using a reflective digital light process (DLP) that involves a rotary color disk.

The first and second imaging lens units (P4, P5) are disposed between the image projector (P0) and the television screen (S1) on the opposite upper and lower sides of the optical axis (A), and cooperate to separate the image output of the image projector (P0) into first and second image portions. In the preferred embodiment, each of the first and second imaging lens units (P4, P5) actually includes a set of two to twenty convex and concave lenses having a total lens index equivalent to that of a convex lens. Since a single convex lens has inherent optical defects, such as field curvature, dispersion and spherical aberration, the use of a set of convex and concave lenses having different refractive indices and dispersions can result in cancellation of the inherent optical defects to minimize image distortion. The first and second imaging lens units (P4, P5) are stacked one above the other for separating the image output of the image projector (P0) into the first and second image portions.

The diaphragm (P3) is disposed on the optical axis (A) between the image projector (P0) and the first and second imaging lens units (P4, P5) for minimizing interference between the first and second image portions that can lead to the formation of ghost images.

The first and second reflecting mirror sets (m1, m2) are disposed rearwardly of the television screen (S1) on the opposite upper and lower sides of the optical axis (A). Each of the first and second reflecting mirror sets (m1, m2) receives a respective one of the first and second image portions from the first and second imaging lens units (P4, P5), and projects the respective one of the first and second image portions to a respective one of the first and second image rendering portions (Sa, Sb) of the television screen (S1).

The first reflecting mirror set (m1) includes an inclined once-reflection mirror unit (R1), a twice-reflection mirror unit (R2), and an inclined thrice-reflection mirror unit (R3). The second reflecting mirror set (m2) also includes an inclined once-reflection mirror unit (R4), a twice-reflection mirror unit (R5), and an inclined thrice-reflection mirror unit (R6).

The inclined once-reflection mirror unit (R1, R4) of each of the first and second reflecting mirror sets (m1, m2) is disposed between the television screen (S1) and one of the first and second imaging lens units (P4, P5), forms an angle of 120 degrees relative to the optical axis (A), and receives the respective one of the first and second image portions from said one of the first and second imaging lens units (P4, P5).

The twice-reflection mirror unit (R2, R5) of each of the first and second reflecting mirror sets (m1, m2) is spaced apart from the associated once-reflection mirror unit (R1, R4), wherein the once-reflection mirror unit (R1, R4) is disposed proximate to the optical axis (A) in relation to the twice-reflection mirror unit (R2, R5). The twice-reflection mirror unit (R2, R5) of each of the first and second reflecting mirror sets (m1, m2) extends parallel to the optical axis (A) and transverse to the television screen (S1), and receives the respective one of the first and second image portions from the associated once-reflection mirror unit (R1, R4).

The thrice-reflection mirror unit (R3, R6) of each of the first and second reflecting mirror sets (m1, m2) is spaced apart from the respective one of the first and second image rendering portions (Sa, Sb) of the television screen (S1), forms an angle of 60 degrees relative to the optical axis (A), receives the respective one of the first and second image portions from the associated twice-reflection mirror unit (R2, R5), and projects the respective one of the first and second image portions to the respective one of the first and second image rendering portions (Sa, Sb) of the television screen (S1). In the preferred embodiment, the image projector (P0) is disposed between the thrice-reflection mirror units (R3, R6) of the first and second reflecting mirror sets (m1, m2).

During operation, source light is generated by the light source (PL), and is processed by planoconvex lenses (P11, P12) to form parallel light beams. Upper and lower parts of the light beams pass respectively through bi-concave lenses (P13, P14) before reaching bi-convex lens (P15). Thereafter, light from the bi-convex lens (P15) passes through upper and lower parts of the video display device (P2) to form the image output of the image projector (P0). The image output is attributed to a light-transmissive dynamic video image formed on the surface of the video display device (P2) via optoelectronic conversion, and is received by the first and second imaging lens units (P4, P5), which have focal points that form a first conjugate relationship with the light source (PL). The first and second imaging lens units (P4, P5) cooperate to separate the image output and form inverted first and second image portions to be projected to the first and second reflecting mirror sets (m1, m2), respectively. Particularly, the first image portion will be received by the once-reflection mirror unit (R1), reflected to the twice-reflection mirror unit (R2), further reflected to the thrice-reflection mirror unit (R3), and finally projected to the first image rendering portion (Sa) of the television screen (S1). By virtue of light divergence, the reflecting areas of the once-reflection, twice-reflection and thrice-reflection mirror units (R1, R2, R3) are increased stepwise. In other words, the thrice-reflection mirror unit (R3) is larger than the twice-reflection mirror unit (R2), whereas the twice-reflection mirror unit (R2) is larger than the once-reflection mirror unit (R1). In the same manner, the second image portion will be received by the once-reflection mirror unit (R4), reflected to the twice-reflection mirror unit (R5), further reflected to the thrice-reflection mirror unit (R6), and finally projected to the second image rendering portion (Sb) of the television screen (S1). The reflecting areas of the once-reflection, twice-reflection and thrice-reflection mirror units (R4, R5, R6) are also increased stepwise, i.e., the thrice-reflection mirror unit (R6) is larger than the twice-reflection mirror unit (R5), and the twice-reflection mirror unit (R5) is larger than the once-reflection mirror unit (R4). The focal point of the television screen (S1) forms a second conjugate relationship with the video display device (P2). It is noted that, in either of the paths from the first or second imaging lens unit (P4, P5) to the television screen (S1), light will complete a full circular turn upon reaching the first or second image rendering portion (Sa, Sb) of the television screen (S1).

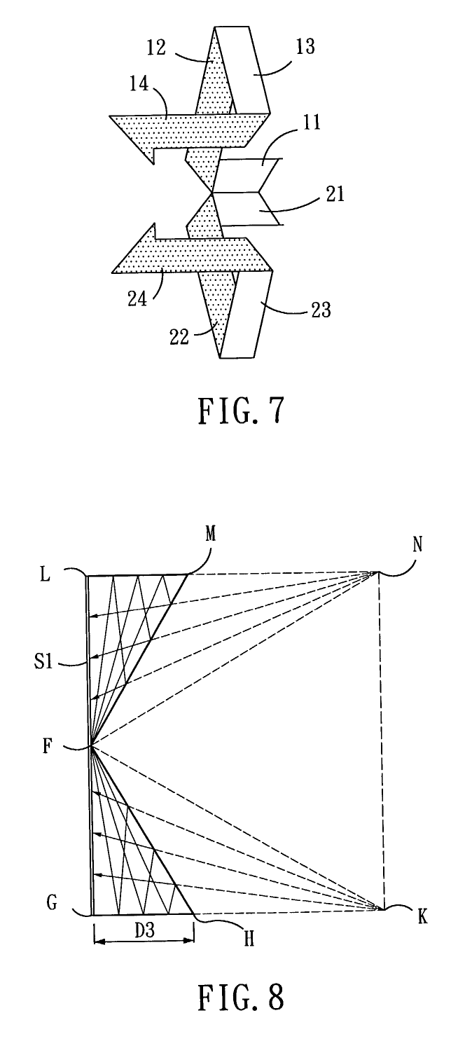

FIG. 7 is a schematic diagram illustrating the image reflecting routes of the rear-projection television set of the preferred embodiment, wherein reference numerals 11 and 21 denote incident light, reference numerals 12 and 22 denote once-reflected light, reference numerals 13 and 23 denote twice-reflected light, and reference numerals 14 and 24 denote thrice-reflected light. In view of the arrangement of the image reflecting routes, the thrice-reflected light 14, 24 will have atop-bottom and left-right reverse relationship with the respective one of the incident light 11, 21.

Due to the first and second reflecting mirror sets (m1, m2), the depth of the rear-projection television set of this invention, as measured from adjacent ends of the twice-reflection and thrice-reflection mirror units (R2, R3, R5, R6) to the television screen (S1), can be reduced to about one-third of that required when the first and second reflecting mirror sets (m1, m2) are not installed. FIG. 8 illustrates how the depth of the rear-projection television set of this invention is reduced with the use of the first and second reflecting mirror sets (m1, m2). In FIG. 8, reference numerals (N, K) denote virtual point sources for projecting the first and second image portions onto the television screen (S1) in a condition where the first and second reflecting mirror sets (m1, m2) are not installed, where as reference numeral (F) denotes an idealized point source for projecting the first or second image portion onto the television screen (S1) in a condition where the first and second reflecting mirror sets (m1, m2) are installed. The television screen (S1) is located at line LG. The idealized point source (F) is disposed at the center of line LG. Lines LM and MF represent reflecting planes functionally equivalent to the first reflecting mirror set (m1). Lines GH and HF represent reflecting planes functionally equivalent to the second reflecting mirror set (m2). Thus, light from the idealized point source (F) is reflected at either line LM or line GH to line MF or line HF for subsequent reflection to either segment LF or segment FG of line LG. Because the geometry of triangles formed by points (F, G, H) and points (F, G, K) are identical to those of triangles formed by points (F, L, M) and points (F, L, N), only the triangles FGH and FGK will be discussed herein for the sake of brevity.

Triangle FGH is a right triangle having an angle ∠GFH of 30 degrees and an angle ∠FHG of 60 degrees. Triangle FGK is also a right triangle having an angle ∠GFK of 60 degrees and an angle ∠FKG of 30 degrees. The distance between point (H) and line LG is (D3). The ratio of the distance (D3) to the height of the television screen (S1) is as follows:

Since ∠GFH is equal to 30 degrees,

tan ∠GFH=GH/FG=tan 30°=√3/3.

Moreover, since D3=GH, and LG=2FG, D3/LG=GH/2FG=(√3/3)/2≈0.29.

In other words, the depth (D3) of the rear-projection television set of this invention should be no smaller than 0.29 times the height of the television screen (S1). As compared to the conventional rear-projection television set shown in FIG. 3, when AB=LG, the ratio of the distance (D3) to the distance (D1) is (√3/6)/(√3/4) or 2/3. The depth (D3) of the rear-projection television set of this invention is thus only 2/3 of that of the conventional rear-projection television set described beforehand.

Referring once again to FIGS. 5 and 6, aside from the shorter depth that can be achieved in the rear-projection television set of this invention, it is noted that the image projector (P0) and the associated optoelectronic components are not located at a level lower than a bottom edge of the television screen (S1), but are instead located rearwardly of the television screen (S1) between the thrice-reflection mirror units (R3, R6) of the first and second reflecting mirror sets (m1, m2). Therefore, the height of the rear-projection television set of this invention is accordingly reduced as compared to that of the conventional rear-projection television set described beforehand.

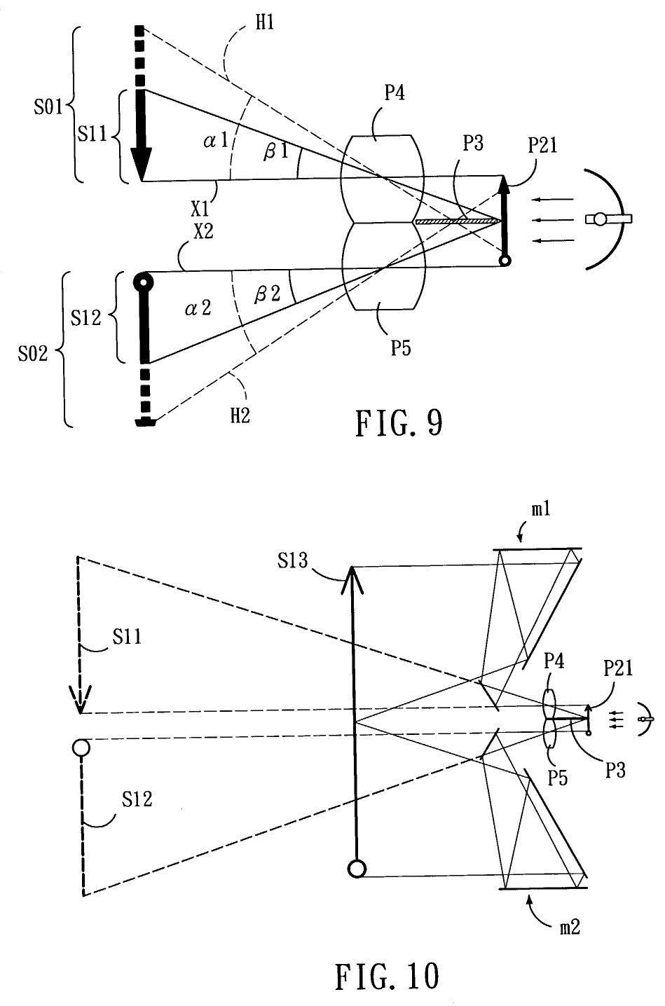

The effect of the diaphragm (P3) will now be described in greater detail with reference to FIG. 9. In FIG. 9, reference numeral (P21) denotes a source image. Imaging lens units (P4, P5) are stacked and function to separate and project upper and lower image portions of the source image (P21), respectively. An inverted projected image (S01) of the source image (P21) is formed through the imaging lens unit (P4), where the projected light beam takes the shape of a half-cone having a cross-section in the form of a right triangle with an upwardly oriented hypotenuse (H1) and a leg side (X1) which is coincident with the axis of imaging lens unit (P4). Another inverted projected image (S02) of the source image (P21) is formed through the imaging lens unit (P5), where the projected light beam also takes the shape of a half-cone having a cross-section in the form of a right triangle with a downwardly oriented hypotenuse (H2) and a leg side (X2) which is coincident with the axis of imaging lens unit (P5). Because the optical axes of the imaging lens units (P4, P5) are parallel to each other, when there is no refracting or reflecting processing involved, each of the projected images (S01, S02) is not only an inverted form of the source image (P21), the top part of the source image (P21) will be adjacent to the bottom part of the source image (P21) due to the arrangement of the inverted projected images (S01, S02). Moreover, because the imaging lens units (P4, P5) have a wide visual field angle, the projecting angle (α1) formed by hypotenuse (H1) and leg side (X1) and the projecting angle (α2) formed by hypotenuse (H2) and leg side (X2) will be expanded accordingly such that the inverted projected images (S01, S02) will overlap. In practice, the projecting angles (α1, α2) should not be greater than 30 degrees to ensure that the projected image will not fall out of the displaying range of the imaging display plane, i.e., the television screen.

The diaphragm (P3) is disposed between the imaging lens units (P4, P5) and the source image (P21) and is disposed parallel to the axis of the source image (P21). The diaphragm (P3) is used to limit the vertical visual field angles of the imaging lens units (P4, P5) such that the resulting projecting angles (β1, β2) are slightly smaller than 30 degrees so as to minimize overlap between the resulting projected images (S11, S12), so as to reduce space requirement of the image reflecting routes, so as to avoid the formation of ghost images attributed to interference between light beams projected from the imaging lens units (P4, P5).

FIG. 10 illustrates how a combined image output (S13) is formed by virtue of the first and second reflecting mirror sets (m1, m2) disposed between the imaging lens units (P4, P5) and the imaging display plane, i.e., the television screen. Each of the image portions from the imaging lens units (P4, P5) will be reflected three times by the respective one of the first and second reflecting mirror sets (m1, m2) before being projected to the imaging display plane such that the combined image output (S13) is a magnification of the source image (P21) and is identical in phase to the source image (P21).

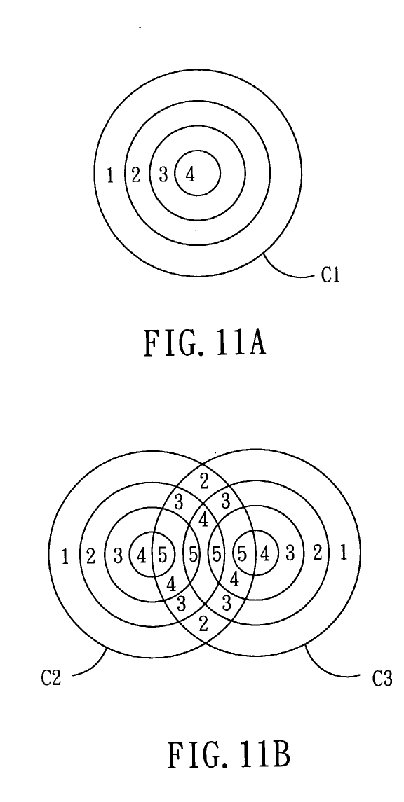

FIG. 11A illustrates contrast distribution of a single image portion from the first or second reflecting mirror set (m1, m2). Concentric circles (C1) in FIG. 11A represent areas of different contrast values ranging from 1 to 4 to illustrate a vignetting effect which is a result of a peripheral portion of a light beam being obstructed by lenses and other components during projection. FIG. 11B illustrates contrast distribution of the combined image output from the first and second reflecting mirror sets (m1, m2). The two groups of concentric circles (C2, C3) in FIG. 11B represent the image portions from the first and second reflecting mirror sets (m1, m2). When the combined image output is formed, due to the lower contrast values of the outer concentric circles, overlapping of the image portions will not result in a noticeable difference in contrast between adjacent parts of the combined image output that can affect the quality of the combined image output.

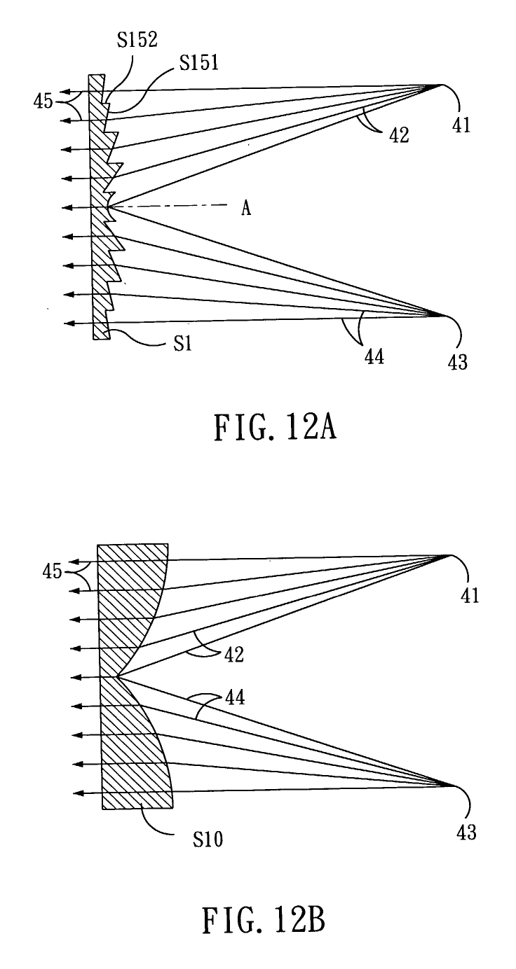

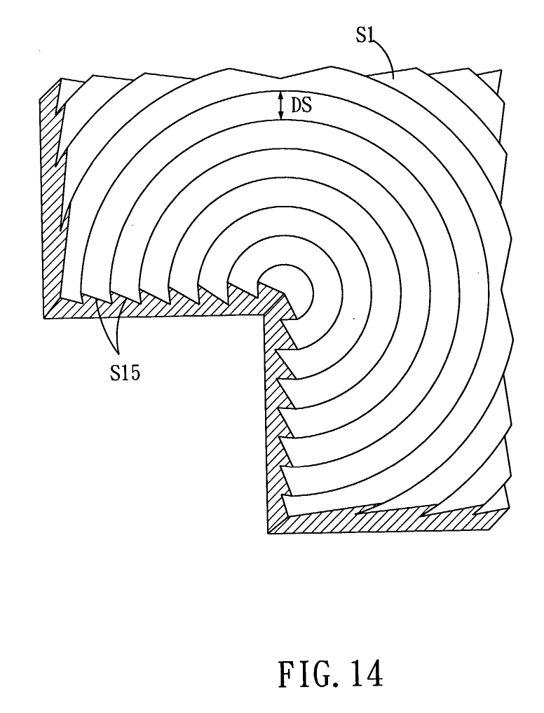

The television screen is the interface between the viewer and the rear-projection television set of this invention. Referring to FIG. 12A, the television screen (S1) of the preferred embodiment is associated with rearwardly disposed upper and lower equivalent virtual projection points 41, 43 for projecting the first and second image portions on the television screen (S1). The television screen (S1) is made of transparent acrylic material, and has a rear side formed with concentric light guiding projections (S15), as best shown in FIG. 14. Each of the light guiding projections (S15) has a generally serrated cross-section with an inclined surface (S151) and a transverse surface (S152) disposed farther from the optical axis (A) (See FIG. 12A) in relation to the inclined surface (S151). The transverse surfaces (S152) of adjacent ones of the light guiding projections (S15) form a distance (DS) (see FIG. 14) that is less than 0.1 mm therebetween. The inclined surfaces (S151) of adjacent ones of the light guiding projections (S15) have varying slopes, and the slopes of the inclined surfaces (S151) of the light guiding projections (S15) are reduced in a radial outward direction relative to the optical axis (A).

Referring once again to FIG. 12A, which is a vertical cross-sectional view of the television screen (S1), light rays 42, 44 that project respectively from the projection points 41, 43 will be refracted as parallel light rays 45 upon passing through the television screen (S1). FIG. 12B illustrates a lens (S10) with a horn-shaped surface that is functionally equivalent to the television screen (S1). Impurities inherently present in the acrylic material will yield a desired non-regulated dispersion effect on the vertical viewing angle.

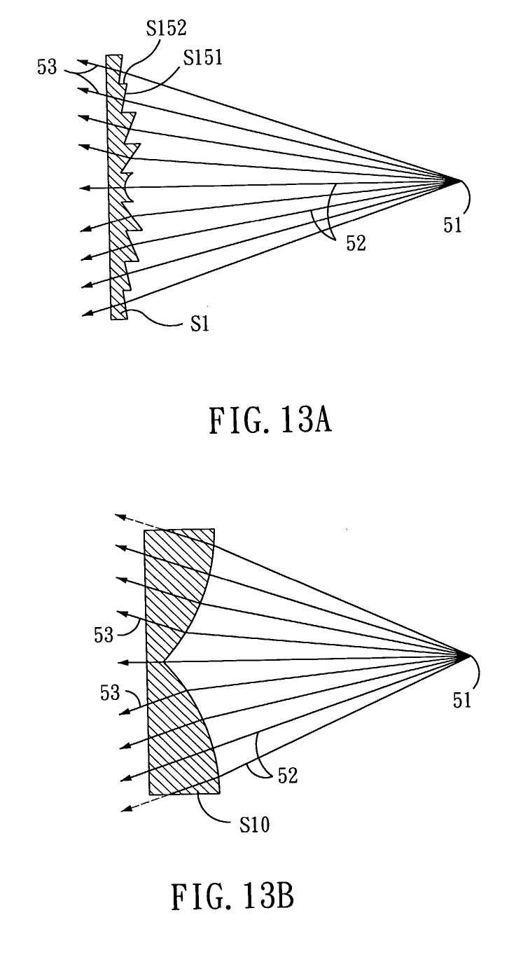

Referring to FIG. 13A, which is a horizontal cross-sectional view of the television screen (S1) light rays 52 from a virtual point source 51 on the optical axis of the television screen (S1) will be refracted to form regulated dispersed light rays 53 by the television screen (S1), and by the impurities inherently present in the acrylic material to form non-regulated dispersed light rays to widen the horizontal viewing angle in a manner similar to that which can be achieved using the lens (S10) with the horn-shaped surface (see FIG. 13B). The television screen (S1) can be used in combination with a lenticular plate for further enhancement of the horizontal viewing angle. The characteristics of high gain and the elimination of hot spots found in the conventional Fresnel lens television screen are also present in the television screen (S1).

It has thus been shown that the effect of the television screen (S1) in the rear-projection television set of the present invention differs from that of the conventional television screen (S2) described beforehand to achieve higher imaging efficiency.

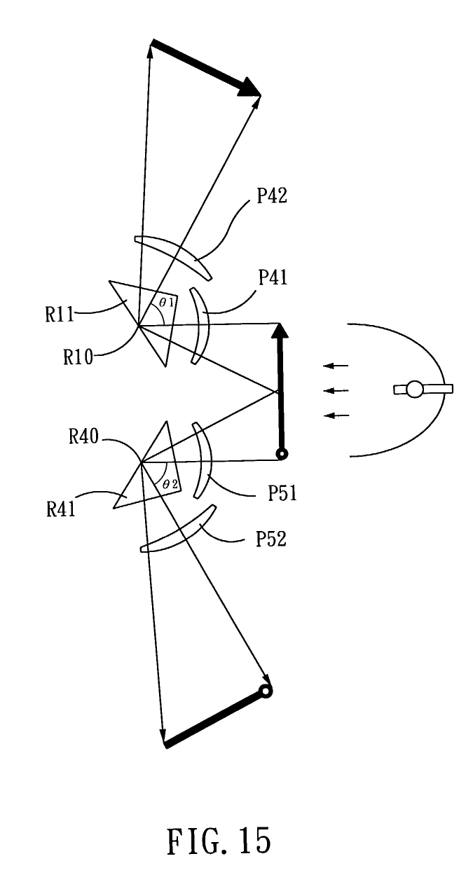

FIG. 15 is a schematic diagram illustrating modified once-reflection mirror units employed in an alternative embodiment of the present invention. Unlike the previous embodiment, each of the once-reflection mirror units includes a triangular prism (R11, R41) disposed between a lens (P41, P51) for incident light and a lens (P42, P52) for outgoing light. Each of the prisms (R11, R41) is shaped as a right triangle, and has an input side for receiving the incident light, an output side for passage of the outgoing light, and a hypotenuse that serves as a reflecting surface for reflecting the incident light from the input side to the output side to serve as the outgoing light. Reflecting points (R10, R40) on the reflecting surfaces of the prisms (R11, R41) coincide with a stop position of the respective pair of the lenses (P41, P42, P51, P52). The axes of the lenses (P41, P42) and the lenses (P51, P52) form an angle (Θ1, Θ2) of 60 degrees therebetween. Outgoing light through each of the lenses (P42, P52) is provided directly to the respective twice-reflection mirror unit (not shown). The arrangement of the once-reflection mirror units of this embodiment results in a shorter image reflecting route and thus in a more compact arrangement as compared to the previous embodiment.

In yet another embodiment of the present invention, the first and second image rendering portions of the television screen are disposed on opposite left and right sides of the optical axis. The first and second imaging lens units are disposed on the opposite left and right sides of the optical axis. The orientations of the three mirror units in each of the first and second reflecting mirror sets are accordingly adjusted so that the first and second image portions from the first and second imaging lens units can be properly projected onto the respective one of the first and second image rendering portions of the television screen in a manner similar to that described hereinabove.

In summary, the presence of the first and second reflecting mirror sets in this invention can reduce the depth of the rear-projection television set to one-third. In addition, since the image projector in this invention is aligned with the axis of television screen instead of being disposed below the television screen as required in the prior art, the height of the rear-projection television set is also reduced to improve the overall aesthetic appeal of the television set.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A rear-projection television set comprising:
a television screen having an optical axis and first and second image rendering portions disposed on opposite sides of said optical axis;
an image projector disposed rearwardly of said television screen, aligned with said optical axis, and generating an image output;
first and second imaging lens units disposed between said image projector and said television screen on the opposite sides of said optical axis, and cooperating to separate the image output of said image projector into first and second image portions; and
first and second reflecting mirror sets disposed rearwardly of said television screen on the opposite sides of said optical axis, each of said first and second reflecting mirror sets receiving a respective one of the first and second image portions from said first and second imaging lens units and projecting the respective one of the first and second image portions to a respective one of said first and second image rendering portions of said television screen.

2. The rear-projection television set as claimed in claim 1, wherein each of said first and second reflecting mirror sets includes:
an inclined once-reflection mirror unit disposed between said television screen and one of said first and second imaging lens units and receiving the respective one of the first and second image portions from said one of said first and second imaging lens units;
a twice-reflection mirror unit spaced apart from said once-reflection mirror unit and receiving the respective one of the first and second image portions from said once-reflection mirror unit; and
an inclined thrice-reflection mirror unit spaced apart from the respective one of said first and second image rendering portions of said television screen, said thrice-reflection mirror unit receiving the respective one of the first and second image portions from said twice-reflection mirror unit and projecting the respective one of the first and second image portions to the respective one of said first and second image rendering portions of said television set.

3. The rear-projection television set as claimed in claim 2, wherein said once-reflection mirror units of said first and second reflecting mirror sets are disposed proximate to said optical axis in relation to said twice-reflection mirror units, said image projector being disposed between said thrice-reflection mirror units of said first and second reflecting mirror sets.

4. The rear-projection television set as claimed in claim 3, wherein said once-reflection mirror unit of each of said first and second reflecting mirror sets forms an angle of 120 degree relative to said optical axis, said twice-reflection mirror unit of each of said first and second reflecting mirror sets extending parallel to said optical axis and transverse to said television screen, said thrice-reflection mirror unit of each of said first and second reflecting mirror sets forming an angle of 60 degrees relative to said optical axis.

5. The rear-projection television set as claimed in claim 1, wherein said image projector includes a light source module and a video display device disposed at an output side of said light source module, said light source module including a light source and a condenser lens set disposed between said light source and said video display device.

6. The rear-projection television set as claimed in claim 1, further comprising a diaphragm disposed on said optical axis between said image projector and said first and second imaging lens units, said diaphragm minimizing interference between the first and second image portions.

7. The rear-projection television set as claimed in claim 1, wherein said television screen has a rear side formed with concentric light guiding projections, each of said light guiding projections having a generally serrated cross-section with an inclined surface and a transverse surface disposed farther from said optical axis in relation to said inclined surface.

8. The rear-projection television set as claimed in claim 7, wherein said transverse surfaces of adjacent ones of said light guiding projections form a distance that is less than 0.1 mm therebetween.

9. The rear-projection television set as claimed in claim 7, wherein said inclined surfaces of adjacent ones of said light guiding projections have varying slopes, the slopes of said inclined surfaces of said light guiding projections being reduced in a radial outward direction relative to said optical axis.

10. The rear-projection television set as claimed in claim 2, wherein said once-reflection mirror unit of each of said first and second reflecting mirror sets includes a triangular prism having an input side for receiving incident light, an output side for passage of outgoing light, and a reflecting surface for reflecting the incident light from said input side to said output side to serve as the outgoing light.
